(19) United States
(12) Patent Application Publication
(10) Pub. No.: US 2025/0272490 A1
(43) Pub. Date: Aug. 28, 2025

(54) APPARATUS AND METHOD FOR TRAINING GENERATIVE LANGUAGE MODEL AND INFERENCE OF GENERATIVE LANGUAGE MODEL

(71) Applicant: ELECTRONICS AND TELECOMMUNICATIONS RESEARCH INSTITUTE, Daejeon (KR)

(72) Inventor: Yo Han Lee, Daejeon (KR)

(21) Appl. No.: 19/057,342

(22) Filed: Feb. 19, 2025

(30) Foreign Application Priority Data
Feb. 26, 2024 (KR) 10-2024-0027212

(51) Int. Cl. G06F 40/289; G06F 16/334

(52) U.S. Cl. CPC G06F 40/289; G06F 16/3347

(57) ABSTRACT

Provided is a method of training a generative language model. The method includes constructing learning data having a triple form and including input context, a vector of the input context (hereinafter referred to as an “input context vector”), and a next word string of the input context, and training a generative language model to convert a previous output sentence into an input context vector, detect an input context vector that is most similar to the converted input context vector in the learning data having the triple form, and output a next word string of input context corresponding to the detected input context vector.

This application claims priority from and the benefit of Korean Patent Application No. 10-2024-0027212, filed on Feb. 26, 2024, which is hereby incorporated by reference for all purposes as if set forth herein.

### BACKGROUND

### 1. Technical Field

The present disclosure relates to an apparatus and method for training a generative language model and the inference of a generative language model.

### 2. Description of Related Art

Recently, large generative language models (e.g., ChatGPT, BARD, and LLAMA) having an excellent sentence generation ability by training a language model having an artificial neural network structure including a large amount of learning data and many parameters have been in the spotlight. The large generative language models have the excellent sentence generation ability, but concerns about the harm and damage of sentences that are generated by the large generative language models have increased because the versatility of the large generative language models is increased. Accordingly, methods, such reinforcement learning from human feedback or prompt engineering, have been developed.

However, there is still a problem with biased or hateful remarks or even remarks including personal information. Such a problem results from a large amount of learning data, and it is not easy to censor problematic data before the training of a language model. Furthermore, it is very difficult to maintain and repair a large generative language model due to a lot of time and many resources that are necessary to train the large generative language model. Practically, in the case of ChatGPT, the results of analysis including degraded performance as services are continued are also reported.

One of reasons why it is technically difficult to maintain and repair a generative language model is that a relation between input context and a next word is stored in a model parameter. A method of adjusting or additionally learn a model parameter related to problematic data affects other prediction results, which is also known as a catastrophic forgetting problem of an artificial neural network. The catastrophic forgetting problem is a phenomenon in which data learnt in the past are easily forgot when new data are additionally learnt. For this reason, there is a problem in that it is difficult to incorporate recent information into a generative language model.

### PRIOR ART DOCUMENT

### Patent Document

Korean Patent Application Publication No. 10-2022-0098628 (Jul. 12, 2022)

### SUMMARY

Various embodiments are directed to providing an apparatus and method for training a generative language model and the inference of a generative language model, which train a generative language model that non-parametrically infers a next word of input context and perform inference by applying the trained generative language model.

However, objects of the present disclosure to be achieved are not limited to the aforementioned object, and other objects may be present.

A method of training a generative language model according to a first aspect of the present disclosure may include constructing learning data having a triple form and including input context, a vector of the input context (hereinafter referred to as an “input context vector”), and a next word string of the input context, and training a generative language model to convert a previous output sentence into an input context vector, detect an input context vector that is most similar to the converted input context vector in the learning data having the triple form, and output a next word string of input context corresponding to the detected input context vector.

Furthermore, an apparatus for training a generative language model according to a second aspect of the present disclosure may include memory configured to construct learning data having a triple form and including input context, a vector of the input context (hereinafter referred to as an “input context vector”), and a next word string of the input context and to store a program for training a generative language model based on the learning data, and a processor configured to train the generative language model so that the generative language model converts a previous output sentence in the generative language model into an input context vector, detects an input context vector that is most similar to the converted input context vector in the learning data having the triple form, and then outputs a next word string of an input context corresponding to the detected input context vector, by executing the program stored in the memory.

Furthermore, an inference method of a generative language model according to a third aspect of the present disclosure may include generating, as a query context vector, input context received from a user by encoding the input context, detecting K support context vectors most similar to the query context vector in learning data having a triple form and including a vector of the input context (hereinafter referred to as an “input context vector”), and a next word string of the input context, connecting a next word string corresponding to the support context vector to the received input context, and selecting, as a final output, one of input contexts connected to a plurality of word strings when the next word string is an end word of a sentence.

A computer program according to another aspect of the present disclosure executes the apparatus and method for training a generative language model and the inference of a generative language model and is stored in a computer-readable recording medium.

Other details of the present disclosure are included in the detailed description and the drawings.

According to the embodiments of the present disclosure, it is possible to handle various problems by providing the method that is effective in detecting and controlling a bias, disgust, or personal information.

Specifically, the existing generative language model requires a lot of additional learning or many complicated measures in order to control a problem attributable to learning data. In contrast, an embodiment of the present disclosure has an advantage in that a language model can be controlled and maintained and repaired efficiently and rapidly by enabling such problems to be solved in a way to simply delete learning data.

Furthermore, the up-to-date status of a language model can be easily maintained in a way to add new data by converting the new data into learning data having a triple form when the new data are added to a generative language model.

Effects of the present disclosure which may be obtained in the present disclosure are not limited to the aforementioned effects, and other effects not described above may be evidently understood by a person having ordinary knowledge in the art to which the present disclosure pertains from the following description.

### BRIEF DESCRIPTION OF THE DRAWINGS

FIG. 1 is a flowchart of an inference method of a generative language model according to an embodiment of the present disclosure.

FIG. 2 is a diagram illustrating an example in which learning data having a triple form are constructed in an embodiment of the present disclosure.

FIG. 3 is a diagram illustrating an example in which an input context vector is constructed in an embodiment of the present disclosure.

FIG. 4 is a flowchart of an inference method of a generative language model according to an embodiment of the present disclosure.

FIG. 5 is a diagram illustrating an example in which personal information is included in a user's utterance in an embodiment of the present disclosure.

FIG. 6 is a diagram illustrating an example in which an utterance through a method of generating a next word string is controlled in an embodiment of the present disclosure.

FIG. 7 is a block diagram of an apparatus for training a generative language model according to an embodiment of the present disclosure.

### DETAILED DESCRIPTION

Advantages and characteristics of the present disclosure and a method for achieving the advantages and characteristics will become apparent from the embodiments described in detail later in conjunction with the accompanying drawings. However, the present disclosure is not limited to embodiments disclosed hereinafter, but may be implemented in various different forms. The embodiments are merely provided to complete the present disclosure and to fully notify a person having ordinary knowledge in the art to which the present disclosure pertains of the category of the present disclosure. The present disclosure is merely defined by the claims.

Terms used in this specification are used to describe embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other elements in addition to a mentioned element. Throughout the specification, the same reference numerals denote the same elements. “And/or” includes each of mentioned elements and all combinations of one or more of mentioned elements. Although the terms “first”, “second”, etc. are used to describe various components, these elements are not limited by these terms. These terms are merely used to distinguish between one element and another element. Accordingly, a first element mentioned hereinafter may be a second element within the technical spirit of the present disclosure.

All terms (including technical and scientific terms) used in this specification, unless defined otherwise, will be used as meanings which may be understood in common by a person having ordinary knowledge in the art to which the present disclosure pertains. Furthermore, terms defined in commonly used dictionaries are not construed as being ideal or excessively formal unless specially defined otherwise.

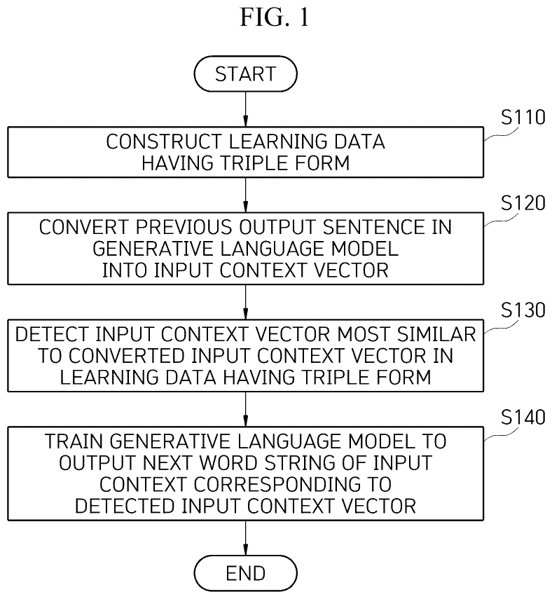

FIG. 1 is a flowchart of a method that is performed by an apparatus 100 for training a generative language model according to an embodiment of the present disclosure.

In an embodiment of the present disclosure, first, learning data having a triple form and including input context and an input context vector and next word string of the input context, is constructed (S110).

In an embodiment, the learning data having the triple form may be constructed from learning data having a sentence form. A vocabulary set having a minimum word unit is generated from the learning data having the sentence form by using a statistical method, such as byte-pair encoding (BPE). Next, each sentence in the learning data having the sentence form is indicated as a word string defined in the vocabulary set. The word string is separated in an arbitrary chunk unit.

In this case, various methods, such as a method of constructing a predetermined number of one or more chunks in a minimum word unit, a method using a dictionary in which compound nouns are defined, or a method using an entity name recognition model, may be applied to a method of constructing the arbitrary chunk in the word string.

Next, learning data having a triple form and including a word string having a predetermined length or less, which is disposed prior to each separated chunk, as a next string including an input context, an input context vector obtained by converting the input context into one vector over a neural network capable of processing an input context having a time-series form, and a chunk disposed after the input context may be constructed.

In this case, the input context vector may be determined by using a method of using a vector corresponding to the last word of the input context in the last hidden layer of the neural network or averaging or max-pooling a vector corresponding to all of the words of the input context that is input to the neural network.

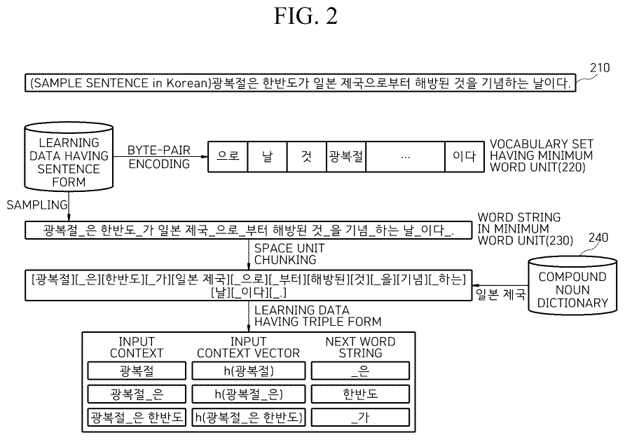

FIG. 2 is a diagram illustrating an example in which learning data having a triple form are constructed in an embodiment of the present disclosure. In this case, FIG. 2 illustrates a process of converting an example sentence into learning data having a triple form and including a chunk in a space unit by using a compound noun dictionary.

The example of FIG. 2 illustrates that a vocabulary set having a minimum word unit is constructed (220) with respect to an original 210 “ [symbol] [symbol] [symbol] [symbol] ” (meaning “National Liberation Day is a day that commemorates the liberation of the Korean Peninsula from the Japanese Empire” in English) and after the original is constructed as a word string defined in the vocabulary set (230), the original is chunked by using a compound noun dictionary (240). In this case, according to a space chunking rule, “ [symbol] ” (meaning “Japanese Empire” in English) needs to be divided into “ [symbol] ” (meaning “Japanese” in English) and “ [symbol] ” (meaning “Empire” in English), but is chunked as one word string because “ [symbol] ” (meaning “Japanese Empire” in English) has been defined in the compound noun dictionary.

However, in an embodiment of the present disclosure, the compound noun dictionary is not essential. Accordingly, if it is difficult to use the compound noun dictionary or entity name recognition, a chunk may be defined as a minimum unit word string having the number of predefined one or more words.

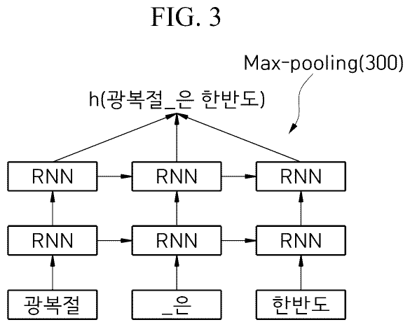

FIG. 3 is a diagram illustrating an example in which an input context vector is constructed in an embodiment of the present disclosure. In this case, FIG. 3 illustrates a process of converting input context into an input context vector through maximum pooling 300 of a time-series-based neural network.

In an embodiment of the present disclosure, a recurrent neural network (RNN), that is, one of time-series neural networks, has been exemplarily illustrated in order to construct an input context vector, but the present disclosure is not essentially limited thereto. A time-series neural network having a structure, such as a gated recurrent unit (GRU) or a transformer, may be applied in order to construct an input context vector.

Referring back to FIG. 1, next, a generative language model converts a previous output sentence into an input context vector (S120), and detects an input context vector that is the most similar to the converted input context vector in the learning data having the triple form (S130).

Next, the generative language model is trained to output a next word string of input context corresponding to the detected input context vector (S140). In this manner, in an embodiment of the present disclosure, the generative language model performs learning so that the generative language model can generate a sentence.

In an embodiment of the present disclosure, a method of non-parametrically generating a next word based on a comparison between input context vectors is adopted, unlike in the existing generative language model that stores a relation between previous context and a next word is stored in a model parameter. According to such a structure, a generative language model can be effectively controlled, maintained, and repaired in a way to delete problematic data or old data from learning data when the problematic data or old data are present, convert new data into learning data having a triple form, and then add the learning data to a data learning dataset.

In an embodiment of the present disclosure, in order to perform the training of a generative language model for a method of generating a non-parametric sentence, it is important to well express input context as an input context vector. That is, it is important for the generative language model to be trained to well understand the sequence and meanings of words of input context and to effectively express corresponding information as one vector.

In an embodiment, contrastive learning may be used as learning for the conversion of an input sentence vector. First, N (N is a natural number) data are constructed as query data by sampling an arrangement including the N data in a learning dataset having a triple form.

Next, an input context vector is calculated from each input context in the query data, and is constructed as a query context vector.

Next, a plurality (S, S is a natural number) of support data having an input context vector that is the closest to the query context vector in the learning data having the triple form is selected. In this case, the input context vector included in the plurality of support data is called a support context vector. In this case, a distance between vectors may be measured based on a Euclidean distance or a cosine distance. Furthermore, a close vector may be efficiently found by using a clustering scheme.

Next, data that belong to the support data and that have a next word string similar to that of the query data are classified as positive support data. Data that belong to the support data, but do not have a next word string similar to that of the query data are classified as negative support data. In this case, similarity between the word strings may be defined based on whether the word strings are perfectly identical with each other or the setting of a comparison between a distance between word embedding vectors and a preset critical value.

Next, a generative language model may be trained so that an output value of a loss function in Equation 1, which is constructed to decrease a distance between the query data and the positive support data and increase a distance between the query data and the negative support data, is minimized.

$$ℒ = \frac{1}{N} {\sum }_{i = 1}^{N} log ( \frac{{\sum }_{j = 1}^{{S}^{+}} exp ( \frac{d [ Wh ( {x}_{i} ) , h ( {x}_{j} ) ]}{τ} )}{{\sum }_{j = 1}^{{S}^{+}} exp ( \frac{d [ Wh ( {x}_{i} ) , h ( {x}_{j} ) ]}{τ} ) + {\sum }_{j = 1}^{{S}^{-}} exp ( \frac{d [ Wh ( {x}_{i} ) , h ( {x}_{j} ) ]}{τ} )} ) \qquad ( 1 )$$

In Equation 1, W indicates a learnable real value matrix of [symbol] ^{m×m}, m indicates the size of a context vector, d[⋅,⋅] indicates a distance between two vectors, τ indicates a parameter having a positive real value that may be adjusted for training stabilization, h(xᵢ) indicates a query context vector, h(x) indicates a support context vector, S⁺ indicates a positive support data index, and S-indicates a negative support data index.

When the training of the generative language model is completed as described above, the generative language model may output an inferred sentence in accordance with a user input. In order to output the sentence for the user input, first, the generative language model generates input context, that is, a word string received from a user, as a query context vector by encoding the input context over the time-series neural network.

Next, the generative language model detects K support context vectors that are the closest to the query context vector in the learning data having the triple form, according to the method of measuring a distance between vectors.

Next, the generative language model repeats and performs a process of connecting a next word string corresponding to the support context vector to the received input context, and performs the above process until a next word string is an end word of the sentence.

When the above process is repeated and performed, K current input contexts are generated by connecting a next word string corresponding to the K support context vectors detected in the first process and previous input context. Accordingly, a total number of support context vectors detected with respect to K current input contexts in a next process will be K*K(K²).

In order to maintain K query context vectors that are increased as such a generation process is repeated, K² results that are generated up to now are scored. K results may be selected among the scored results.

In an embodiment in which K² intermediate results are scored and K intermediate results are selected among the scored results, K support context vectors having the closest distance to a query context vector may be selected among K² support context vectors that are the closest to K query context vectors generated in a next process.

In another embodiment, K support context vectors having the smallest perplexity (PPL) that is calculated with respect to K² support context vectors that are the closest to K query context vectors generated in a next process may be selected. In this case, the PPL may be calculated according to Equation 2.

$$log ( P P L ( W ) ) = - \frac{1}{N} {\sum }_{t = 1}^{\vert W \vert} log ( {p}_{θ} ( {w}_{t} \vert {w}_{1 : t - 1} ) ) \qquad ( 2 )$$

In Equation 2, W indicates a result word string that is generated up to now, |W| is the length of the result word string, and p_{θ}(wₜ|w_{1:t-1}) is a probability that a word wₜ will be predicted when a word string w_{1:t-1} up to t−1 is given in a statistical model θ.

Thereafter, if a next word string is an end word of a sentence, any one of input contexts connected to K word strings may be selected as a final output. For example, one word string of K generated word strings may be selected as a final output on the basis of the PPL score.

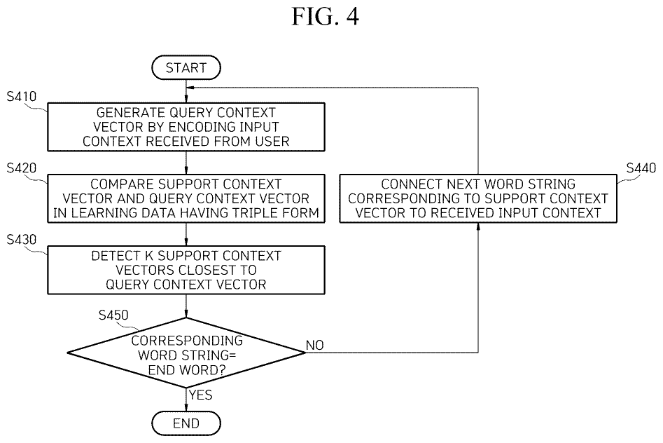

FIG. 4 is a flowchart of an inference method of a generative language model according to an embodiment of the present disclosure. FIG. 4 illustrates a process of outputting a sentence for a user input when K=1 as a process of outputting a sentence by inferring a generative language model in accordance with the user input after the generative language model is trained through a learning process. In this case, contents that are redundant with the contents described with reference to FIGS. 1 to 3 are omitted, but are not necessarily excluded.

First, input context received from a user is generated as a query context vector by encoding the input context (S410).

Next, a support context vector and the query context vector in learning data having a triple form are compared (S420). K support context vectors closest to the query context vector as a result of the comparison are detected (S430).

Next, a next word string corresponding to the support context vector is connected to the received input context (S440).

When a next word string is an end word of a sentence, input context connected to the word string is output (S450).

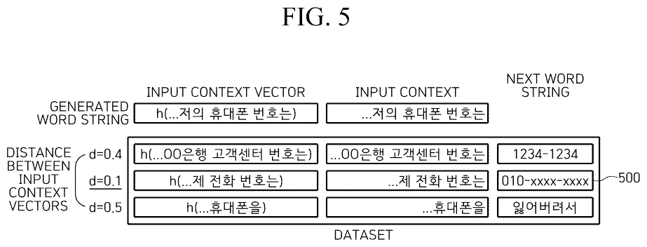

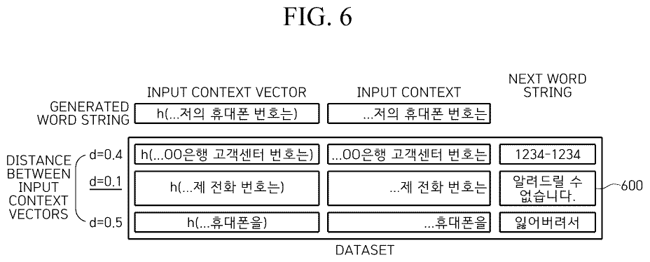

FIG. 5 is a diagram illustrating an example in which personal information is included in a user's utterance in an embodiment of the present disclosure. FIG. 6 is a diagram illustrating an example in which an utterance through a method of generating a next word string is controlled in an embodiment of the present disclosure.

FIGS. 5 and 6 illustrate examples in which when personal information is included in an utterance, the utterance is effectively controlled even without additional learning by changing data that cause a problem.

For example, as illustrated in FIG. 5, if context “ [symbol] ” (meaning “My cell phone number is” in English) has been generated up to now, the time-series neural network calculates an input context vector by encoding the input context, and generates a next word string corresponding to the most similar input context vector by comparing the calculated input context vector with all of input context vectors that are present in a data set.

Accordingly, in the example of FIG. 5, if data, such as “ [symbol] ” (meaning “My phone number is” in English), have been selected, a next word string including personal information, such as “010-xxxx-xxxx”, is generated (500).

In this case, in an embodiment of the present disclosure, if the next word string is determined to be a preset alternative target word string, the next word string may be deleted, and the deleted next word string may be substituted with the alternative target word string. That is, an utterance including corresponding personal information can be fundamentally blocked by changing a next word string of data selected as illustrated in FIG. 6 into “ [symbol] ” (meaning “not available for sharing” in English) (600). As described above, in an embodiment of the present disclosure, an utterance can be effectively controlled even without additional learning or a data change.

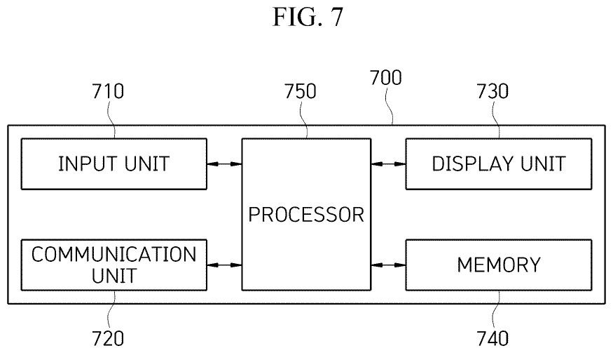

In the aforementioned description, each of steps S110 to S250 may be further divided into additional steps or the steps may be combined into smaller steps depending on an implementation example of the present disclosure. Furthermore, some of the steps may be omitted, if necessary, and the sequence of the steps may be changed. Furthermore, although contents are omitted, the contents of FIGS. 1 to 6 may also be applied to the method of generating signal images in FIG. 7.

FIG. 7 is a block diagram of an apparatus for training a generative language model according to an embodiment of the present disclosure.

The apparatus for training a generative language model according to an embodiment of the present disclosure includes an input unit 710, a communication unit 720, a display unit 730, memory 740, and a processor 750.

The input unit 710 receives a word or sentence from a user. In addition, the input unit 710 generates input data in accordance with a user input to the apparatus 700 for training a generative language model. The user input may include a user input relating to data to be processed by the apparatus 700 for training a generative language model. The input unit 710 may include at least one input means. The input unit 710 may include a key board, a key pad, a dome switch, a touch panel, a touch key, a mouse, and a menu button in addition to a camera and a microphone.

The communication unit 720 transmits and receives data between internal components, and performs communication with an external device, such as an external server. The communication unit 720 may include both a wired communication module and a wireless communication module. The wired communication module may be implemented as a power line communication device, a telephone line communication device, cable home (MoCA), Ethernet, IEEE1294, an integrated wired home network, or an RS-485 controller. Furthermore, the wireless communication module may be constructed as a module for implementing a function, such as a wireless LAN (WLAN), Bluetooth, an HDR WPAN, UWB, ZigBee, impulse radio, a 60 GHz WPAN, binary-CDMA, a wireless USB technology, a wireless HDMI technology, 5th generation (5G) communication, long term evolution-advanced (LTE-A), long term evolution (LTE), or wireless fidelity (Wi-Fi).

The display unit 730 displays display data according to an operation of the apparatus 700 for training a generative language model. The display unit 730 may display input and output words or sentences. The display unit 730 includes a liquid crystal display (LCD), a light emitting diode (LED) display, an organic light-emitting diode (OLED) display, a micro electro mechanical systems (MEMS) display, and an electronic paper display. The display unit 730 may be implemented as a touch screen in combination with the input unit 710.

The memory 740 constructs learning data having a triple form and including input context, a vector of the input context (hereinafter referred to as an “input context vector”), and a next word string of the input context, and stores programs for training a generative language model based on the learning data. In this case, the memory 440 commonly refers to a nonvolatile storage device that retains information stored therein although power is not supplied to the nonvolatile storage device and a volatile storage device. For example, the memory 120 may include NAND flash memory such as a compact flash (CF) card, a secure digital (SD) card, a memory stick, a solid-state drive (SSD), and a micro SD card, a magnetic computer memory device such as a hard disk drive (HDD), and an optical disc drive such as CD-ROM and DVD-ROM.

The processor 750 may control at least another component (e.g., a hardware or software component) of the apparatus 700 for training a generative language model by executing software, such as a program, and may perform various data processing or operations.

By executing a program stored in the memory, the processor trains a generative language model so that the generative language model converts a previous output sentence into an input context vector in the generative language model, detects an input context vector that is most similar to the converted input context vector in learning data having a triple form, and then outputs a next word string of input context corresponding to the detected input context vector.

The apparatus for training a generative language model according to an embodiment of the present disclosure may perform an inference process by applying a trained generative language model as the training of the generative language model is completed. In contrast, the generative language model trained by the apparatus for training a generative language model may be implemented in a form in which the generative language model operates by being mounted on an apparatus for the inference of a generative language model, which is independently divided.

The inference method of a generative language model according to an embodiment of the present disclosure may be implemented in the form of a program (or application) in order to be executed by being combined with a computer, that is, hardware, and may be stored in a medium.

The aforementioned program may include a code coded in a computer language, such as C, C++, JAVA, Ruby, or a machine language which is readable by a processor (CPU) of a computer through a device interface of the computer in order for the computer to read the program and execute the methods implemented as the program. Such a code may include a functional code related to a function, etc. that defines functions necessary to execute the methods, and may include an execution procedure-related control code necessary for the processor of the computer to execute the functions according to a given procedure. Furthermore, such a code may further include a memory reference-related code indicating at which location (address number) of the memory inside or outside the computer additional information or media necessary for the processor of the computer to execute the functions needs to be referred. Furthermore, if the processor of the computer requires communication with any other remote computer or server in order to execute the functions, the code may further include a communication-related code indicating how the processor communicates with the any other remote computer or server by using a communication module of the computer and which information or media needs to be transmitted and received upon communication.

The stored medium means a medium, which semi-permanently stores data and is readable by a device, not a medium storing data for a short moment like a register, cache, or a memory. Specifically, examples of the stored medium include ROM, RAM, CD-ROM, a magnetic tape, a floppy disk, optical data storage, etc., but the present disclosure is not limited thereto. That is, the program may be stored in various recording median in various servers which may be accessed by a computer or various recording median in a computer of a user. Furthermore, the medium may be distributed to computer systems connected over a network, and a code readable by a computer in a distributed way may be stored in the medium.

The description of the present disclosure is illustrative, and a person having ordinary knowledge in the art to which the present disclosure pertains will understand that the present disclosure may be easily modified in other detailed forms without changing the technical spirit or essential characteristic of the present disclosure. Accordingly, it should be construed that the aforementioned embodiments are only illustrative in all aspects, and are not limitative. For example, elements described in the singular form may be carried out in a distributed form. Likewise, elements described in a distributed form may also be carried out in a combined form.

The scope of the present disclosure is defined by the appended claims rather than by the detailed description, and all changes or modifications derived from the meanings and scope of the claims and equivalents thereto should be interpreted as being included in the scope of the present disclosure.

What is claimed is:

1. A method of training a generative language model, which is performed by a computer, the method comprising:
constructing learning data having a triple form and comprising input context, a vector of the input context (hereinafter referred to as an “input context vector”), and a next word string of the input context; and
training a generative language model to convert a previous output sentence into an input context vector, detect an input context vector that is most similar to the converted input context vector in the learning data having the triple form, and output a next word string of input context corresponding to the detected input context vector.

2. The method of claim 1, wherein the constructing of the learning data having the triple form comprises:
separating learning data having a sentence form in an arbitrary chunk unit; and
constructing the learning data having the triple form and having a word string having a predetermined length or less, which is disposed prior to the each separated chunk, as a next word string comprising an input context, an input context vector converted from the input context in a vector form, and a chunk disposed after the input context.

3. The method of claim 2, wherein the separating of the learning data having the sentence form in the arbitrary chunk unit comprises:
constructing a vocabulary set having a minimum word unit when receiving the learning data having the sentence form;
constructing each sentence in the learning data having the sentence form as a word string defined in the vocabulary set; and
separating the word string in the arbitrary chunk unit.

4. The method of claim 2, wherein the input context vector is converted in a vector form by inputting the input context to a predetermined neural network, and is a vector corresponding to a last word of the input context in a last hidden layer of the neural network.

5. The method of claim 2, wherein the input context vector is converted in a vector form by inputting the input context to a predetermined neural network, and is constructed based on averaging or max-pooling results of a vector corresponding to all of words of the input context that is input to the neural network.

6. The method of claim 1, further comprising:
constructing, as query data, an arrangement comprising N data, among the learning data having the triple form by sampling the arrangement;
constructing an input context vector as a query context vector by calculating the input context vector from each input context in the query data;
selecting a plurality of support data having an input context vector closest to the query context vector in the learning data having the triple form;
classifying the support data into positive support data and negative support data based on similarity with a next word string of the query data; and
training the generative language model so that a loss function defined based on the positive support data and the negative support data is minimized.

7. The method of claim 6, wherein the training of the generative language model so that the loss function defined based on the positive support data and the negative support data is minimized comprises training the generative language model so that the loss function constructed to decrease a distance between the query data and the positive support data and increase a distance between the query data and the negative support data is minimized.

8. The method of claim 6, further comprising:
generating, as a query context vector, input context received from a user by encoding the input context;
detecting K support context vectors closest to the query context vector in the learning data having the triple form;
connecting a next word string corresponding to the support context vector to the received input context; and
selecting, as a final output, one of input context connected to a plurality of word strings when the next word string is an end word of a sentence.

9. The method of claim 8, wherein the detecting of the K support context vectors closest to the query context vector in the learning data having the triple form comprises:
detecting K² support context vectors closest to K query context vectors generated by encoding an input context connected to the next word string; and
detecting the K support context vectors having a closest distance from the query context vector, among the K² support context vectors.

10. The method of claim 8, wherein the detecting of the K support context vectors closest to the query context vector in the learning data having the triple form comprises:
detecting K² support context vectors closest to K query context vectors generated by encoding an input context connected to the next word string; and
detecting K support context vectors having smallest perplexity (PPL) calculated with respect to the K² support context vectors.

11. The method of claim 8, wherein the connecting of the next word string corresponding to the support context vector to the received input context comprises:
deleting the next word string when the next word string is determined to be a preset alternative target word string; and
substituting the deleted next word string with an alternative word string.

12. An apparatus for training a generative language model, comprising:
memory configured to construct learning data having a triple form and comprising input context, a vector of the input context (hereinafter referred to as an “input context vector”), and a next word string of the input context and to store a program for training a generative language model based on the learning data; and
a processor configured to train the generative language model so that the generative language model converts a previous output sentence in the generative language model into an input context vector, detects an input context vector that is most similar to the converted input context vector in the learning data having the triple form, and then outputs a next word string of an input context corresponding to the detected input context vector, by executing the program stored in the memory.

13. An inference method of a generative language model, which is performed by a computer, the inference method comprising:
generating, as a query context vector, input context received from a user by encoding the input context;
detecting K support context vectors closest to the query context vector in learning data having a triple form and comprising input context, a vector of the input context (hereinafter referred to as an “input context vector”), and a next word string of the input context;
connecting a next word string corresponding to the support context vector to the received input context; and
selecting, as a final output, one of input contexts connected to a plurality of word strings when the next word string is an end word of a sentence.
